(19) United States
(12) Patent Application Publication
(10) Pub. No.: US 2023/0371580 A1
(43) Pub. Date: Nov. 23, 2023

(54) METHOD OF INSPECTION OF ROD SHAPED ARTICLES

(71) Applicant: PHILIP MORRIS PRODUCTS S.A., Neuchatel (CH)

(72) Inventors: Eugenio Navacchia, Bologna (IT); Ivano Montoleone, Pianoro (IT)

(21) Appl. No.: 18/030,338

(22) PCT Filed: Oct. 20, 2021
(86) PCT No.: PCT/EP2021/079121

§ 371 Date: Apr. 5, 2023

(30) Foreign Application Priority Data
Oct. 21, 2020 (EP) 20203167.0

(51) Int. Cl. A24C 5/34; A24C 5/345; A24C 5/01

(52) U.S. Cl. CPC A24C 5/3412; A24C 5/345; A24C 5/01

(57) ABSTRACT

The invention relates to a method of inspection of rod-shaped articles, the method comprising: —providing a first drum having a plurality of seats; —providing at least one seat of the plurality of seats of the first drum with an inductive sensor comprising a coil; —providing the at least one seat of the plurality of seats of the first drum with a rod-shaped article including a first susceptor, the first susceptor comprising a conductive material; —inserting the rod-shaped article in the coil of the inductive sensor; —detecting a maximum value or a minimum value of a parameter function of the impedance of the coil during the insertion of the rod-shaped article; —discarding the rod-shaped article on the basis of the maximum value or the minimum value of the parameter function of the impedance.

The present invention relates to a method to inspect rod shaped articles, preferably components of an aerosol generating article. The inspection according to the method of the invention is performed by means of an inductive sensor.

Aerosol generating devices are known, which comprise an aerosol-forming substrate and an inductive heating device. The inductive heating device comprises an induction source which produces an alternating electromagnetic field which induces heat generating eddy currents and hysteresis losses in a susceptor. The susceptor is in thermal proximity of the aerosol-forming substrate, for example a tobacco substrate. The heated susceptor in turn heats the aerosol-forming substrate which comprises a material which is capable of releasing volatile compounds that can form an aerosol.

In some components, the susceptor is positioned inside a component of the aerosol generating article.

Because of manufacturing tolerances, it may occur that the susceptor in the component is not in the desired position, or it does not have the proper orientation. If the susceptor remains in the not correct position or orientation, a lack of product conformity in terms of deliveries of the aerosol when the component is used in an aerosol generating device may be obtained.

It is therefore desirable to detect such defects as early as possible to ensure that only compliant products are produced and that unnecessary costs and waste are avoided.

Furthermore, the components, including those containing the susceptors, are processed at high speed, such as 5000 components each minute. Thus, the time window in which such components can be checked to determine their compliance to the production requirements is relatively short. For example, when the components are positioned in the drum of a combiner, they have a high rotational speed, and a time window for a sensor to capture data necessary to evaluate the shape, position or presence or absence of the susceptor is of about 200 milliseconds.

It is thus desirable to detect the defects relating to the susceptors at a relatively high speed.

According to an aspect, the invention relates to a method of inspection of rod-shaped articles, the method comprising: providing a first drum having a plurality of seats. Preferably, the method comprises: providing at least one seat of the plurality of seats of the first drum with an inductive sensor comprising a coil. Preferably, the method comprises providing the at least one seat of the plurality of seats of the first drum with a rod-shaped article including a first susceptor, the first susceptor comprising a conductive material. Preferably, the method comprises inserting the rod-shaped article in the coil of the inductive sensor. Preferably, the method includes detecting a maximum value or a minimum value of a parameter function of the impedance of the coil during the insertion of the rod-shaped article. Preferably, the method comprises discarding the rod-shaped article on the basis of the maximum value or the minimum value of the parameter function of the impedance.

The method of the invention includes providing a first drum. The first drum defines a drum rotational axis around which the first drum is adapted to rotate. The first drum can be mechanically driven, for example by a drum drive comprising a gear or a toothed belt. The first drum may be driven by an electrical drum drive. The first drum is preferably cylindrically shaped. The first drum preferably comprises an outer surface. The outer surface is for example a substantially cylindrical surface having as a geometrical centre the drum rotational axis.

The first drum is adapted to transport and rotate a rod-shaped article around its rotational axis. Preferably, the first drum is adapted to transport and rotate a plurality of rod-shaped articles. Preferably, the first drum is adapted to transport and rotate N rod-shaped articles, where 5<N<100, more preferably 20<N<50.

The first drum comprises at least a seat, preferably formed on the outer surface of the drum. The first drum is preferably adapted to hold the rod-shaped article during transport in the seat. For example, the first drum is adapted to hold the rod-shaped article in the seat during a rotation of the first drum around its rotational axis. The seat preferably extends longitudinally along a seat axis. The seat is adapted, as the first drum rotates, to receive the rod-shaped article. Preferably, the rod-shaped article fits in the seat with its longitudinal axis parallel to the seat axis. Preferably, each seat is so configured that the rod-shaped article can be housed therein when the seat axis and the longitudinal axis of the rod-shaped article are parallel. More preferably, the seat axis and the longitudinal axis of the rod-shaped article are congruent. The seat is preferably adapted to house a single rod-shaped article.

Preferably, the seat axis is parallel to the rotational axis of the first drum. So, when the rod-shaped article is positioned in the seat, the longitudinal axis of the rod-shaped article is preferably parallel to the rotational axis of the first drum.

Preferably, the first drum comprises N seats, where 5<N<100, more preferably 20<N<50. Preferably, all seats are formed on the peripheral surface of the first drum. More preferably, the seats are equally spaced apart about the outer surface of the first drum. In some embodiments, the first drum comprises 40 seats.

Preferably, all seats present in the first drum have the same geometrical shape. For example, each seat comprises a receiving surface adapted to contact an outer surface of the rod-shaped article. The receiving surface preferably comprises a portion of a recessed surface, for example a cylindrical surface. The receiving surface is a portion of the outer surface of the first drum. The receiving surface may be a portion of a cylindrical surface having a diameter equal to or slightly bigger than the diameter of the rod-shaped article transported by the first drum. The axis of the receiving surface defines the seat axis.

Preferably, the seat axis is parallel to the rotational axis of the first drum, therefore when the rod-shaped articles are positioned in the seats of the first drum, their longitudinal axes are parallel to the rotational axis of the first drum.

Preferably, the first drum also comprises a first side surface and a second side surface, located at the two opposite sides of the outer surface. Preferably, the seat extends from the first side surface to the opposite second side surface. The seat may reach the first side surface or the second side surface or both, so that the seat is “open” at the two ends. Alternatively, the seat ends do not reach the first side surface or the second side surface, and in this case the seat is a “closed” seat.

Each seat preferably includes a suction aperture, connected to a suction system or pneumatic system, adapted to hold the rod-shaped article in the seat by suction while the drum rotates. More than a suction aperture may be present, depending for example on the size and weight of the rod-shaped article.

According to the invention, a rod-shaped article is provided into a seat of the first drum. Preferably, a rod-shaped article is provided in a plurality of seats of the first drum. Preferably, the rod-shaped article defines a longitudinal axis. Preferably, the rod-shaped article defines a first end and a second end.

Preferably, a cross section of the rod-shaped article along a plane perpendicular to its longitudinal axis is a circle or an oval. However, the rod-shaped article may also have the cross-section of a rectangle or of a polygon. The rod-shaped article comprises an outer surface, preferably substantially cylindrical, which extends along the longitudinal axis. In case of substantially cylindrical rod-shaped articles, the longitudinal axis corresponds to the axis of the cylinder.

Preferably, the rod-shaped article includes an aerosol generating article, or a component of an aerosol generating article, or more than one component of an aerosol generating article. The component of the aerosol generating article may include an aerosol forming substrate. The aerosol forming substrate may include a homogenized tobacco material.

The rod-shaped article further comprises a first susceptor. The first susceptor is preferably in thermal contact with the aerosol forming substrate. The thermal contact is created in order to heat the aerosol forming substrate. Upon heating, the aerosol forming substrate releases aerosol. Preferably, the first susceptor is surrounded by the aerosol forming substrate. Preferably, the first susceptor is completely inserted in the component of the rod-shaped article, that is, the first susceptor is not visible from the outside of the rod-shaped article. Preferably, the first susceptor is surrounded in all directions by the aerosol forming substrate.

Preferably, the first susceptor is closer to the first end of the rod-shaped article than to the second end of the rod-shaped article. Given a plane perpendicular to the longitudinal axis and dividing the rod-shaped article in a first half including the first end and a second half including the second end, preferably the first susceptor is predominantly in the first half. Preferably, the first susceptor is located at or in proximity of the first end of the rod-shaped article. Preferably, the first susceptor is completely inserted in a component of the rod-shaped article. Preferably, the first susceptor extends from the first end to the second end of the component of the rod-shaped article. Preferably, the first susceptor defines a longitudinal axis. Preferably, the first susceptor is inserted in the rod-shaped article so that the longitudinal axis of the first susceptor is parallel to the longitudinal axis of the rod-shaped article. Preferably, the longitudinal axis of the first susceptor is parallel or forms an angle lower than 20 degrees with the longitudinal axis of the rod-shaped article. More preferably, the longitudinal axis of the first susceptor and the longitudinal axis of the rod-shaped article are congruent.

The longitudinal axis of the first susceptor may be a symmetry axis of the first susceptor.

The first susceptor is realized in a conductive material. Preferably, the first susceptor is realized in metal. Preferably, the first susceptor is realized in ferromagnetic material. Although the first susceptor is realized in conductive material, it may be covered by other materials, for example solid, such a layer of a different material, or liquid, such as gel.

Preferably, the first susceptor has the shape of a strip. Preferably, the thickness of the first susceptor is comprised between 30 micrometres and 60 micrometres. Preferably, the length of the first susceptor is comprised between 5 millimetres and 20 millimetres.

Preferably, the rod-shaped article is wrapped in a wrapping sheet.

At least a seat of the drum is associated with an inductive sensor. More preferably a plurality of seats of the drum, and even more preferably all seats of the drum, are associated with an inductive sensor. In the technical field, inductive sensor and induction sensor are synonyms. Inductive sensors use currents induced by magnetic fields to detect nearby conductive objects, such as metal objects. The inductive sensor comprises a coil, which is an inductor, to generate a magnetic field, such as a high frequency magnetic field. If there is conductive object, such as the first susceptor embedded in the rod-shaped article, near the changing magnetic field, current will flow in the conductive object. This resulting current flow in the conductive object sets up a new magnetic field that opposes the original magnetic field formed by the current flowing in the coil. The net effect is that it changes the impedance, such for example the resistance, of the system “coil and first susceptor” in the inductive sensor. By measuring the impedance, the sensor can determine when a conductive material has been brought nearby the inductive sensor. The change in the impedance depends on the type of conductive material in which the object is made, on the distance between the object and the sensor, and on the size and shape of the object.

The inductive sensor may be for example the Texas instrument integrated circuit LCD 1101. Preferably, the inductive sensor measures a resistance equivalent to the first susceptor. The inductive sensor may measure the impedance and resonant frequency of the equivalent system “coil and first susceptor” by regulating the oscillation amplitude in a closed-loop configuration at a constant level, while monitoring the energy dissipated by the resonator. By monitoring the amount of power injected into the resonator, the inductive sensor can determine the equivalent parallel resistance of the resonator, which it returns as a digital value.

Thus, an inductive sensor is associated with a seat of the drum, preferably a plurality of inductive sensors is associate with a plurality of seats of the drum, a sensor per seat, to detect a parameter which is function of the impedance of the coil. Preferably, a parameter which is function of the system “coil and first susceptor” is detected.

The parameter function of the impedance is preferably the impedance Z itself of the coil, or the equivalent resistance of the coil, or the inductance of the coil.

The inductive sensor includes a coil which defines an inner volume. The inner volume is delimited by the windings of the coil. For example, the inductive sensor includes a cylindrical coil comprising a plurality of windings of a wire. Preferably, the coil does not include a core, that is, the inner volume includes air. Preferably, the inner volume of the coil is large enough that the rod-shaped article can be inserted inside the coil, at least for a portion. The total length of the coil is preferably longer than the length of the first susceptor. With length of the first susceptor, in case a measurement of the length of the first susceptor is desired, the nominal length of the first susceptor is meant. For a proper insertion, the inner diameter of the coil is preferably wider than the diameter of the rod-shaped article. Preferably, the coil defines a longitudinal axis, called coil axis in the following.

Preferably, the rod-shaped article is inserted in the coil of the inductive sensor. The insertion can be complete, that is, the whole rod-shaped article is housed in the inner volume of the coil, or only partially, that is, only a portion of the rod-shaped article is housed in the inner volume of the coil. However, preferably, the rod-shaped article is inserted in the coil so that the whole first susceptor is located within the inner volume of the coil during the insertion.

Preferably, the coil of the inductive sensor is mounted at the seat of the first drum in such a way that the coil axis and the seat axis are parallel to each other. This preferably in turn means that the coil axis and the longitudinal axis of the rod-shaped article, when present in the seat, are parallel as well.

The inductive sensor is used in order to measure the parameter function of the impedance of the coil which is altered due to the presence of the first susceptor inside the rod-shaped article. For this reason, the inspection device preferably includes a control unit. The control unit is electrically connected to the inductive sensor. The control unit elaborates signals coming from the inductive sensor in order to evaluate the parameter function of the impedance, such as the impedance itself. The control unit may be a part of the inductive sensor. The control unit may also be adapted to calculate the maximum or minimum of the parameter function of the impedance, as detailed below.

In order to insert the rod-shaped article in the inductive sensor, a relative movement between the rod-shaped article and the inductive sensor takes place.

Preferably, the insertion of the rod-shaped article into the coil takes place from the first end of the rod-shaped article. The first susceptor is preferably closer to the first end than the second end, thus an insertion from the first end requires a shorter coil than an insertion from the second end in order for the susceptor to be completely inserted in the inner volume of the coil. In this way, only a limited portion of the rod-shaped article needs to enter into the coil to investigate a characteristic of the first susceptor.

Preferably, the movement to insert the rod-shaped article in the coil is a linear movement in a direction parallel to the coil axis. Preferably, the movement is a linear movement parallel to the seat axis. The movement can be either a movement of the rod-shaped article towards the coil (and the coil is stationary), a movement of the coil towards the rod-shaped article (and the rod-shaped article is stationary), or a movement of both the coil and the rod-shaped article towards each other. It is to be understood that when it is said that an element is stationary, reference is made to the outer surface of the drum. Thus, the coil or the rod-shaped articles may be stationary with respect to the outer surface of the drum. The outer surface itself is rotation during the rod-shaped articles' inspection.

The movement of the coil, or of the rod-shaped articles, or of both, can be performed in many different ways. For example, the coil comprises a first semi-coil and a second semi-coil. The first semi-coil and the second semi-coil are two portions of the coil sectioned along a plane parallel to the longitudinal axis of the coil. Therefore, the first semi-coil and the second semi-coil may have different sizes. More preferably, the first semi-coil and the second semi-coil are each a half of the coil when sectioned along a plane containing the longitudinal axis of the coil. Each semi-coil includes a plurality of half-windings. Each half winding is for example an arc of a circumference, more preferably half circumference. The arc of circumference of the first semi-coil and the corresponding arc of circumference of the second semi-coil forms a winding of the coil. The first semi-coil and the second semi-coil are movable one with respect to the other. The movement performed by the first semi-coil, or the second semi-coil, or both, is preferably a translation, that is, a linear movement. The first semi-coil and the second semi-coil may be in a first operative position in which the first semi-coil and the second semi-coil are in contact in such a way that a complete coil is formed, and an electrical current can flow into the windings of the coil. In this first operative position, each of the half-windings of the first semi-coil corresponds to a half winding of the second semi-coil. Further, to each half winding of the second semi-coil, corresponds a half winding of the first semi-coil. In this first operative position, the contact between the first semi-coil and the second semi-coil is such that a current can flow in the coil formed by the two semi-coils. The inductive sensor can therefore detect a characteristic of the susceptor. Conductive strips may for example be formed on the outer surface of the drum, where the second semi-coil or the first semi-coil slides.

With this system, the rod-shaped article remains stationary when positioned in the seat and the coil “forms” around it. No movement of the rod-shaped article, once is positioned on the seat of the drum, is thus required in order to obtain a measurement of the parameter function of the impedance of the susceptor. Measurement can be very fast due to the quick measurements possible with an inductive sensor. No complex mechanical parts are required in order to move the rod-shaped article. The rod-shaped article avoids deformations due to improper handling in the drum.

Alternatively, the rod-shaped article may be pushed inside the coil. The insertion of the rod-shaped article may for example take place via the ejection of a flow of compressed air takes place when the rod-shaped article is positioned in the seat of the drum. In this case, the coil is stationary, and the rod-shaped article moves.

The measurement performed by the inductive sensor is preferably not a single measurement but a plurality of measurements. The various measurements are preferably performed with a fixed frequency. Therefore, the measurement of the value function of the impedance of the coil is preferably repeated several times in a given time interval. The repetition is due to the fact that the parameter function of the impedance of the coil changes depending on the distance of the first susceptor from the coil and also from the degree of insertion of the first susceptor inside the coil. The maximum or minimum of this value (depending on how the value is calculated) is reached when the whole first susceptor is inserted inside the coil.

In operation, the rod-shaped article is positioned in a seat of the drum where the measurement of the parameter function of the impedance of the coil as altered by the first susceptor by the inductive sensor is performed. The positioning into the seat of the rod-shaped article may be due for example to a transfer from another drum or from a conveyor.

When the rod-shaped article is seated in the seat, current is made to flow in the whole length of the coil and the detection of the parameter function of the impedance can take place. If the first susceptor is not present, no Eddy current are created and there is no change in the magnetic field formed by the coil. In this case therefore the impedance of coil does not change during the insertion. The value of the impedance of the coil “unaltered” is thus the maximum or minimum to be considered.

In the other cases, the value of the impedance changes while the rod-shaped article approaches the coil (or the coil approaches the rod-shaped article) and this change is detected by the various measurements performed by the inductive sensor. The variation is detected preferably till the whole first susceptor is inserted in the coil. Preferably, the variation is also detected when the rod-shaped article is extracted from the coil.

The measurements of the parameter function of the impedance of the coil have a maximum or a minimum or both. This maximum or minimum is an indicium of characteristics of the first susceptor. Indeed, the signal outputted by the inductive sensor depends on the material, size, shape and distance of the first susceptor. Being the material known, and the distance measurable, the size or shape of the first susceptor can be measured. Knowing the size, such as by knowing the weight, the dimensions of the first susceptor may be obtained, for example from a minimum or maximum of the signal relative to the impedance of the system “coil and first susceptor” measured by the inductive sensor, impedance of the “coil and first susceptor” that depends also on the characteristics of the first susceptor. In this way, whether the susceptor is a whole susceptor can be for example determined.

With a simple and quick measurement, the rod-shaped article can be discarded in case the maximum or minimum of the value function of the impedance is not as desired. Non-suitable values of maximum or minimum of the value function of the impedance may indicate a too short first susceptor, a too big first susceptor, a first susceptor lacking material, the lack of first susceptor, more than a first susceptor inserted together, or others.

Preferably, the method includes: comparing the maximum value or the minimum value of a parameter function of the impedance with a threshold. Preferably, the method also includes discarding the rod-shaped article on the basis of the comparison. Preferably, this comparison may be done by the control unit electrically connected to the inductive sensor. Preferably, the control unit is adapted to receive a signal from the inductive sensor and to compare the signal with a threshold. The inductive sensor preferably measures a parameter function of impedance of the system formed by coil and first susceptor. In the first susceptor, made of conductive material, Eddy currents are generated which in turn form a magnetic field. The value function of the impedance measured by the inductive sensor depends on the characteristics of the first susceptor. In some embodiments of the inductive sensor, the inductive sensor measures a resistance. In particular, the inductive sensor is adapted to measure a series resistance equivalent to the first susceptor. Preferably, the first susceptor is considered acceptable if its maximum of the resistance as measured by the inductive sensor is comprised between 200 milliOhm and 500 milliOhm. Due to the fact that the composition of the first susceptor is known, the comparison of the maximum or minimum value of the impedance with a threshold allows to determine characteristics of the first susceptor.

No changes in the impedance of the coil are present if the first susceptor is absent from the rod-shaped article, considering that no other conductive objects are generally included in the rod-shaped article besides the susceptor.

Preferably, the method comprises: measuring the length of the first susceptor on the basis of the maximum value or the minimum value of the parameter function of the impedance of the coil during the insertion of the rod-shaped article. The measurement made by the inductive sensor may relate to the size of the first susceptor. The first susceptor length may be calculated by checking the variation of the signal emitted by the inductive sensor according to the position of the rod-shaped article in the coil. The signal emitted by the inductive sensor depends on the impedance of the system coil and first susceptor. This parameter function of the impedance reaches a maximum (or a minimum) level when the whole first susceptor has entered inside the coil and begins to decrease (or increase) as soon as the end of the first susceptor exits the coil. By comparing this signal to the positions of the rod-shaped article inside the coil, it is possible to determine the exact length of the first susceptor.

Preferably, the method comprises: measuring the parameter function of the impedance of the coil as a function of time during the insertion of the rod-shaped article. The measurement may be performed at a given frequency. The start of the measurements can be for example the detection of the presence of a rod-shaped article in the seat of the drum. The frequency may also be variable: for example, a first frequency may be used when the rod-shaped article and the coil are at a distance above a given distance from each other, and a second frequency may be used when the rod-shaped article and the coil are at a distance lower than the given distance from each other. Preferably, the second frequency is higher than the first frequency. In this way, more measurements are taken when the coil and rod-shaped article are close to each other or the insertion has taken place. Preferably, the measurements are taken during the whole insertion of the rod-shaped article in the coil. Preferably, the method comprises the step of extracting the rod-shaped article from the coil. Preferably, the measurements are taken during the extraction of the rod-shaped article from the coil.

More preferably, the method comprises: measuring the length of the first susceptor on the basis of the profile defined by the parameter function of the impedance of the coil as a function of time during the insertion of the rod-shaped article in the coil.

Preferably, the first susceptor has a nominal length, and the step of providing at least one seat of the plurality of seats of the first drum with an inductive sensor comprising a coil includes: providing at least one seat of the plurality of seats of the first drum with an inductive sensor comprising a coil having a length longer than the nominal length of the first susceptor. In order to properly evaluate the maximum or the minimum of the parameter function of the impedance, the whole susceptor is preferably inserted in the coil. For this purpose, preferably the coil is longer than the susceptor. In a preferred embodiment of the invention, the length of the coil is comprised between 20 millimetres and 40 millimetres. The length of the coil is taken along the coil axis.

Preferably, the rod-shaped article has a longitudinal axis and the first drum has a rotational axis, and the step of providing the at least one seat of the plurality of seats of the first drum with a rod-shaped article including a first susceptor includes: providing the at least one seat of the plurality of seats of the first drum with the rod-shaped article having the longitudinal axis substantially parallel to the rotational axis. The rod-shaped articles preferably move with their axes parallel to the rotational axis for an easy inspection.

Preferably, the seat has a seat axis and the coil has a coil axis, and the step of providing at least one seat of the plurality of seats of the first drum with an inductive sensor comprising a coil includes: providing the at least one seat of the plurality of seats of the first drum with the seat axis substantially parallel to the coil axis. The rod-shaped articles preferably move with their axes parallel to the rotational axis for an easy inspection. In order to measure a characteristic of the first susceptor, the rod-shaped article is inserted in the coil. If coil and rod-shaped article have their respective axes parallel to each other, the relative movement to be performed between coil and rod-shaped article is a simple linear movement. The mechanical construction is thus relatively simple.

Preferably, the drum has a rotational axis and each seat of the plurality defines a seat axis, the seat axis and the rotational axis being parallel to each other. Preferably, all seats have their seat axis parallel to the rotational axis of the first drum. Preferably, all seat axes are parallel to each other. This in turn may mean that, when the rod-shaped articles are located in the seats, the longitudinal axes of the rod-shaped articles are parallel to the rotational axis of the first drum. In order to determine a characteristic of the first susceptor, a relative movement between the rod-shaped article and the coil is needed (for example, either a semi-coil moves, or the rod-shaped article moves, or both). The configuration where the rod-shaped articles are parallel to the rotational axis of the first drum maximises the number of rod-shaped articles which the first drum may host at the same time.

Preferably, the coil has a diameter comprised between 10 millimetres and 20 millimetres. The diameter of the coil herein considered is the inner diameter of the coil, that is, the available diameter for the insertion of the rod-shaped article. The size of the coil is such that the rod-shaped article can be inserted.

Preferably, the rod-shaped article has a first end and a second end, and the first susceptor is located at the first end of the rod-shaped article. Preferably, the step of inserting the rod-shaped article in the coil of the inductive sensor comprises: inserting the rod-shaped article in the coil of the inductive sensor so that the first end of the rod-shaped article is located within the coil. Preferably, the rod-shaped article has the first susceptor “asymmetrically mounted” inside. The first susceptor is for example preferably present closer to the first end of the rod-shaped article than to the second end. Preferably therefore the insertion of the rod-shaped article in the coil is performed from the first end of the rod-shaped article. In this way, a smaller coil is needed to house the whole first susceptor.

Preferably, the step of discarding the rod-shaped article on the basis of the maximum value or the minimum value of the parameter function of the impedance comprises: discarding the rod-shaped if the maximum value or the minimum value of the parameter function of the impedance is outside a pre-set range.

Preferably, the rod-shaped article has a first end and a second end and a second susceptor, the first susceptor being located at the first end of the rod-shaped article and the second susceptor being located at the second end of the rod-shaped article. Preferably, the method comprises: providing a second drum having a plurality of seats. Preferably, the method comprises: providing at least one seat of the plurality of seats of the second drum with an inductive sensor comprising a coil. Preferably, the method comprises: transferring the rod-shaped article from the first drum to the second drum so that the rod-shaped article is housed in the at least one seat of the plurality of seats of the second drum. Preferably, the method comprises: inserting the rod-shaped article in the coil of the inductive sensor of the second drum so that the second end of the rod-shaped article is within the coil. Preferably, the method comprises: detecting a maximum value or a minimum value of the parameter function of the impedance of the coil of said inductive sensor of said second drum during the insertion of the rod-shaped article. Preferably, the method comprises: discarding the rod-shaped article on the basis of the maximum value or the minimum value of the parameter function of the impedance.

In some embodiments, the rod-shaped article may include two susceptors. The method thus uses two drums, the first drum and the second drum, each of the first drum and second drum being used according to the first aspect of the invention above described. Two drums are used when the rod-shaped article includes a first susceptor and a second susceptor. Preferably, the first susceptor and the second susceptor are located at the two opposite distal ends of the rod-shaped article. Thus, a first inductive sensor measures the impedance of the coil (of the first inductive sensor) altered by the first susceptor located at the first end of the rod-shaped article. A second inductive sensor measures the impedance of the coil (of the second inductive sensor) altered by the second susceptor present at the second end of the rod-shaped article. Preferably, in the first drum the relative movement between the rod-shaped article and the coil is along a first axis, while the relative movement between the rod-shaped article and the coil in the second drum is along an axis parallel to the first axis, but with opposite direction. Preferably, after the inspection in the first drum, the rod-shaped article is transferred to the second drum. Preferably, the transfer takes place only if the first susceptor is not defective. The transfer is made according to a standard method in the field. A fast complete check of both first susceptor and second susceptor is thus achieved.

Preferably, the first drum and the second drum have the same characteristics. Therefore, the second drum has the same characteristics as above described with reference to the first drum.

Preferably, the first susceptor and the second susceptor have the same characteristics. Therefore, the second susceptor has the same characteristics as above described with reference to the first susceptor.

Preferably, the inductive sensor in the first drum and the inductive sensor in the second drum have the same characteristics. Therefore, the inductive sensor in the second drum has the same characteristics as above described with reference to the inductive sensor in the first drum.

Preferably, the step of inserting the rod-shaped article in the coil of the inductive sensor comprises: sliding the rod-shaped article on a bottom surface of the seat so as to insert the rod-shaped article in the coil. More preferably, the step of sliding the rod-shaped article on a bottom surface of the seat so as to insert the rod-shaped article in the coil comprises: pushing the rod-shaped article inside the coil by means of an air flow. For example, the air flow may be produced by a compressed air system. The compressed air system may include a nozzle which is adapted to eject a flow of compressed air. The main direction of the flow of compressed air is preferably parallel to the longitudinal axis of the seat. Therefore, preferably the flow of compressed air impinges on one of the ends of the rod-shaped article and pushes the same towards the coil. Preferably, the coil is aligned with the seat, that is, the longitudinal axis of the coil is parallel or coincident to the longitudinal axis of the rod-shaped article. Preferably, the longitudinal axis of the coil is parallel to the mean axis of the flow of compressed air.

Preferably, the compressed air system includes a second nozzle to eject a compressed air flow opposite to the first compressed air flow to push the rod-shaped article outside the coil. Preferably, the second nozzle faces the first nozzle at a given distance. Preferably, the given distance is longer than the length of the rod-shaped article. Preferably, the first nozzle and the second nozzle are located at the opposite sides of the coil.

Preferably, the coil includes a first semi-coil and a second semi-coil, the first semi-coil and the second semi-coil being movable from a first operative position where the first semi-coil and the second semi-coil are in contact to each other forming the coil where current can flow to a second operative position where the first semi-coil and the second semi-coil are separated from each other and no current can flow, and vice-versa. Preferably, the step of inserting the rod-shaped article in the coil of the inductive sensor comprises: moving the first semi-coil and the second semi-coil from the second operative position to the first operative position. Preferably, when the rod-shaped article is positioned in the seat, the first semi-coil and the second semi-coil are in the second operative position, separated from each other, so that a volume above the seat is “free” and the rod-shaped article can be positioned in the seat without any obstacle. When the rod-shaped article is in the seat, the first semi-coil and the second semi-coil are moved to the first operative position and the detection of the characteristic of the susceptor can take place. The actuator thus moves the first semi-coil or the second semi-coil till the half-windings of the first semi-coil correspond to their complementary half-windings of the second semi-coil. The control unit commands the actuator to move the second semi-coil till the first operative position is reached. The command of the control unit may be triggered by a further sensor, which senses the presence or absence of the rod-shaped article in the seat. Thus, when the sensor senses the presence of the rod-shaped article, it sends a signal to the control unit which in turn sends a signal to the actuator to bring the first semi-coil and the second semi-coil in the first operative position and the detection by the inductive sensor may take place. Alternatively, the command sent by the control unit to the actuator is synchronized with the rotation of the first drum. While the first drum rotates, the control unit is adapted to receive or determines the drum angular speed and the point of insertion of the rod-shaped article in the first drum. From this information, the control unit may calculate the angular position of each rod-shaped article in the first drum. The control unit may command the actuators of the seats where an inductive sensor is present so that the first semi-coil and the second semi-coil move from the second operative position to the first operative position at a given frequency.

Preferably, the method comprises the step of: calibrating the inductive sensor using a rod-shaped article including a first susceptor or a second susceptor or both having a length equal to a nominal length.

Preferably, the step of discarding a rod-shaped article is performed by a rejection device, which is adapted to reject rod-shaped articles on the basis of a signal emitted by the inductive sensor regarding the maximum or minimum of the parameter function of the impedance. If the inductive sensor senses that one of the characteristics of the first susceptor inside the rod-shaped article is outside specifications, for example the first susceptor is absent or its length is too short or too long, then the rod-shaped article is preferably not further processed. The rod-shaped article containing the “defective” first susceptor is for example transferred to a rejection drum, different from the first drum where rod-shaped articles containing a valid susceptor are transferred. Preferably, the control unit controls the suction system keeping the rod-shaped article in the seat in such a way that the rod-shaped articles containing defective susceptors are discharged from the seat differently than the rod-shaped article containing valid susceptors. The differentiation between the valid susceptor and defective susceptor is preferably made by the control unit. Preferably, the differentiation is based on the characteristic of the susceptor sensed by the inductive sensor.

With “impedance” the complex-valued generalization of resistance is meant. The impedance Z is a complex number representing V (voltage)/I (current). In the case of an ideal inductor L, such as a coil, the impedance Z_{L} is given by the formula:

Z_{L}=jωL

where j is the imaginary unit, ω the angular frequency of the exciting electric signal and L the inductance of the coil.

The equivalent resistance R of the coil, measured in Ohm, is then co L.

In the following, the term “rod-shaped article” may refer to any element which may be included in an aerosol generating article or a complete aerosol generating article. Such elements are known in the art and not further detailed below. For example, such rod-shaped article might include a plug of a filter, a heat source, a tobacco rod, a charcoal element and so on. Preferably, the rod-shaped article is a plant material containing article, in particular a tobacco containing article. The tobacco article might contain a tobacco cut filler or an aerosol-forming reconstituted tobacco. The article may comprise a tobacco rod to be combusted or heated. Rod-shaped articles according to the invention may be whole, assembled aerosol generating articles or elements of aerosol generating articles that are combined with one or more other components in order to provide an assembled aerosol generating article for producing an aerosol, such as for example, the consumable part of a heated smoking device.

Preferably, the elements of the aerosol generating article comprises a tobacco-containing material including volatile tobacco flavour compounds, which are released from an aerosol generating substrate upon heating.

Preferably, the rod-shaped article may include a heat source, or a volatile flavour generating component, for example a menthol capsule, a charcoal element, or a susceptor.

Furthermore, the rod-shaped article may comprise a plurality of components of an aerosol generating article combined together, or even more than an aerosol generating article.

As used herein, the term “susceptor” refers to a material that is capable to convert electromagnetic energy into heat. When located in an alternating electromagnetic field, eddy currents are induced and hysteresis losses occur in the susceptor causing heating of the susceptor. As the susceptor is located in thermal contact or close thermal proximity with the aerosol forming substrate, the aerosol forming substrate is heated by the susceptor such that an aerosol is formed. Preferably, the susceptor is arranged in direct physical contact with the aerosol forming substrate, for example within the aerosol forming tobacco substrate.

The susceptor may be formed from any material that can be inductively heated to a temperature sufficient to generate an aerosol from the aerosol forming substrate. A preferred susceptor may comprise or consist of a ferromagnetic material, for example a ferromagnetic alloy, ferritic iron, or a ferromagnetic steel or stainless steel. A suitable susceptor may be, or comprise, aluminium. Preferred susceptors may be heated to a temperature in excess of 250 degrees Celsius. Suitable susceptors may comprise a non-metallic core with a metal layer disposed on the non-metallic core, for example metallic tracks formed on a surface of a ceramic core. A susceptor may have a protective external layer, for example a protective ceramic layer or protective glass layer encapsulating the susceptor. The susceptor may comprise a protective coating formed by a glass, a ceramic, or an inert metal, formed over a core of susceptor material.

The susceptor may be a multi-material susceptor and may comprise a first susceptor material and a second susceptor material. The first susceptor material is disposed in intimate physical contact with the second susceptor material. The second susceptor material preferably has a Curie temperature that is lower than 500° C. The first susceptor material is preferably used primarily to heat the susceptor when the susceptor is placed in a fluctuating electromagnetic field. Any suitable material may be used. For example, the first susceptor material may be aluminium, or may be a ferrous material such as a stainless steel. The second susceptor material is preferably used primarily to indicate when the susceptor has reached a specific temperature, that temperature being the Curie temperature of the second susceptor material. The Curie temperature of the second susceptor material can be used to regulate the temperature of the entire susceptor during operation. Thus, the Curie temperature of the second susceptor material should be below the ignition point of the aerosol-forming substrate. Suitable materials for the second susceptor material may include nickel and certain nickel alloys.

Preferably, the susceptor has the form of a filament, rod, sheet or band. If the susceptor profile is of constant cross-section, for example a circular cross-section, it has a preferable width or diameter of between about 1 millimeter and about 5 millimeter. If the susceptor profile has the form of a sheet or band, the sheet or band preferably has a rectangular shape having a width preferably between about 2 millimeter and about 8 millimeter, more preferably, between about 3 millimeter and about 5 millimeter, for example 4 millimeter and a thickness preferably between about 0.03 millimeter and about 0.15 millimeter, more preferably between about 0.05 millimeter and about 0.09 millimeter, for example 0.07 millimeter.

Preferably, the rod-shaped article may have a length of between about 5 millimetres and about 20 millimetres, preferably between about 8 millimetres and about 16 millimetres for example of about 12 millimetres in length. In some cases, the rod-shape article may have a length of about 40 millimetres to about 85 millimetres.

In the following, the term “length”, unless otherwise specified, refers to a length of the rod-shaped article along its longitudinal axis.

In the following, the term “rod-shaped” denotes a generally cylindrical element of substantially cylindrical, oval or elliptical cross-section. However, other prismatic forms with different cross sections are also possible.

As used herein, “aerosol generating article” is any article that generates an inhalable aerosol when an aerosol-forming substrate is heated. The term includes articles that comprise an aerosol-forming substrate that is heated by an external heat source, such as an electric heating element. An aerosol-forming article may be a non-combustible aerosol generating article, which is an article that releases volatile compounds without the combustion of the aerosol-forming substrate. An aerosol-forming article may be a heated aerosol generating article, which is an aerosol generating article comprising an aerosol-forming substrate that is intended to be heated rather than combusted in order to release volatile compounds that can form an aerosol. The term includes articles that comprise an aerosol-forming substrate and an integral heat source, for example a combustible heat source.

The aerosol generating article may comprise a mouthpiece element. The mouthpiece element may be located at the mouth end or downstream end of the aerosol generating article.

The aerosol generating article may comprise at least one filter element.

The filter segment may be a cellulose acetate filter plug made of cellulose acetate tow. A filter segment may have low particulate filtration efficiency or very low particulate filtration efficiency. A filter segment may be longitudinally spaced apart from the aerosol-forming substrate. The filter segment may have a length in the longitudinal direction of between about 5 millimetres and about 14 millimetres. The filter segment may have a length of about 7 millimetres.

The plurality of element of the aerosol-generating article may comprise at least one of a support element and an aerosol-cooling element.

Preferably, the aerosol-generating article comprises a wrapper wrapping the plurality of elements of the aerosol-generating article in the form of a rod. The wrapper may comprise at least one of a paper and a foil.

As used herein, the term “aerosol-forming substrate” denotes a substrate formed from or comprising an aerosol-forming material that is capable of releasing volatile compounds upon heating for generating an aerosol. The aerosol-forming substrate may contain a tobacco material or may contain a non-tobacco material or a combination of both, tobacco material and non-tobacco material. The aerosol forming substrate may be cellulose material impregnated with nicotine, preferably comprising one or more flavours. Advantageously, the aerosol-forming substrate comprises tobacco material, preferable homogenised tobacco material, preferably comprising one or more aerosol-formers. As used herein, the term ‘homogenised tobacco material’ denotes a material formed by agglomerating particulate tobacco.

Preferably, the aerosol-forming substrate contains volatile tobacco flavour compounds, which are released from the aerosol forming substrate upon heating. The aerosol-forming substrate may comprise or consist of blended tobacco cut filler or may comprise homogenised tobacco material. Homogenised tobacco material may be formed by agglomerating particulate tobacco. The aerosol forming substrate may additionally comprise a non-tobacco-containing material, for example homogenised plant-based material other than tobacco.

Preferably, the aerosol-forming substrate is a tobacco sheet, preferably crimped, comprising tobacco material, fibers, binder and aerosol former. Preferably, the tobacco sheet is a cast leaf. Cast leaf is a form of reconstituted tobacco that is formed from a slurry including tobacco particles, fiber particles, aerosol former, binder and for example also flavours.

Tobacco particles may be of the form of a tobacco dust having particles in the order of 30 micrometers to 250 micrometers, preferably in the order of 30 micrometers to 80 micrometers or 100 micrometers to 250 micrometers, depending on the desired sheet thickness and casting gap, where the casting gap typically defines the thickness of the sheet. The size of the tobacco particles refers to their Dv95 size in a volume distribution.

Fiber particles may also be included, which include tobacco stem materials, stalks or other tobacco plant material, and other cellulose-based fibers such as wood fibers having a low lignin content. Fiber particles may be selected based on the desire to produce a sufficient tensile strength for the cast leaf versus a low inclusion rate, for example, an inclusion rate between approximately 2 percent to 15 percent. Alternatively, fibers, such as vegetable fibers, may be used either with the above fiber particles or in the alternative, including hemp and bamboo.

Aerosol formers included in the slurry forming the cast leaf or used in other aerosol forming substrates may be chosen based on one or more characteristics. Functionally, the aerosol former provides a mechanism that allows it to be volatilized and convey nicotine or flavouring or both in an aerosol when heated above the specific volatilization temperature of the aerosol former. Different aerosol formers typically vaporize at different temperatures. The aerosol-former may be any suitable known compound or mixture of compounds that, in use, facilitates formation of a dense and stable aerosol and that is substantially resistant to thermal degradation at the operating temperature of an inductive heating device the inductively heatable tobacco substrate shall be used with. An aerosol former may be chosen based on its ability, for example, to remain stable at or around room temperature but able to volatize at a higher temperature, for example, between 40 degree Celsius and 450 degree Celsius.

The aerosol former may also have humectant type properties that help maintain a desirable level of moisture in an aerosol forming substrate when the substrate is composed of a tobacco-based product, particularly including tobacco particles. In particular, some aerosol formers are hygroscopic material that functions as a humectant, that is, a material that helps keep a tobacco substrate containing the humectant moist.

One or more aerosol former may be combined to take advantage of one or more properties of the combined aerosol formers. For example, triacetin may be combined with glycerin and water to take advantage of the triacetin's ability to convey active components and the humectant properties of the glycerin.

Aerosol formers may be selected from the polyols, glycol ethers, polyol ester, esters, and fatty acids and may comprise one or more of the following compounds: glycerin, erythritol, 1,3-butylene glycol, tetraethylene glycol, triethylene glycol, triethyl citrate, propylene carbonate, ethyl laurate, triacetin, meso-Erythritol, a diacetin mixture, a diethyl suberate, triethyl citrate, benzyl benzoate, benzyl phenyl acetate, ethyl vanillate, tributyrin, lauryl acetate, lauric acid, myristic acid, and propylene glycol.

The aerosol-forming substrate may comprise other additives and ingredients, such as flavourants. The aerosol forming substrate preferably comprises nicotine and at least one aerosol-former.

Aerosol generating articles according to the present invention may be in the form of filter combustible cigarettes or other smoking articles in which tobacco material is combusted to form smoke.

Preferably, the aerosol generating article may be substantially cylindrical in shape. The aerosol generating article may be substantially elongated. The aerosol generating article may have a length and a circumference substantially perpendicular to the length. The aerosol generating article may have a total length between about 30 millimetres and about 100 millimetres, more preferably between 40 millimetres and 55 millimetres. The aerosol generating article may have an external diameter between about 5 millimetres and about 12 millimetres, more preferably between 6 millimetres and 8 millimetres.

The invention is defined in the claims. However, below there is provided a non-exhaustive list of non-limiting examples. Any one or more of the features of these examples may be combined with any one or more features of another example, embodiment, or aspect described herein.

Example Ex1: Method of inspection of rod-shaped articles, the method comprising:
providing a first drum having a plurality of seats;
providing at least one seat of the plurality of seats of the first drum with an inductive sensor comprising a coil;
providing the at least one seat of the plurality of seats of the first drum with a rod-shaped article including a first susceptor, the first susceptor comprising a conductive material;
inserting the rod-shaped article in the coil of the inductive sensor;
detecting a maximum value or a minimum value of a parameter function of the impedance of the coil during the insertion of the rod-shaped article;
discarding the rod-shaped article on the basis of the maximum value or the minimum value of the parameter function of the impedance.

Example Ex2: The method according to Ex1, including:
comparing the maximum value or the minimum value of the parameter function of the impedance with a threshold;
discarding the rod-shaped article on the basis of the comparison.

Example Ex3: The method according to Ex1 or Ex2, comprising:
measuring the length of the first susceptor on the basis of the maximum value or the minimum value of the parameter function of the impedance of the coil during the insertion of the rod-shaped article.

Example Ex4: The method according to one or more of the preceding Ex1-Ex3, comprising:
measuring the parameter function of the impedance of the coil as a function of time during the insertion of the rod-shaped article.

Example Ex5: The method according to Ex4, comprising:
measuring the length of the first susceptor on the basis of the profile defined by the parameter function of the impedance of the coil as a function of time during the insertion of the rod-shaped article in the coil.

Example Ex6: The method according to one or more of the preceding Ex1-Ex5, wherein the first susceptor has a nominal length and the step of providing at least one seat of the plurality of seats of the first drum with an inductive sensor comprising a coil includes:
providing at least one seat of the plurality of seats of the first drum with an inductive sensor comprising a coil having a length longer than the nominal length of the first susceptor.

Example Ex7: The method according to one or more of the preceding Ex1-Ex6, wherein the rod-shaped article has a longitudinal axis and the first drum has a rotational axis, and wherein the step of providing the at least one seat of the plurality of seats of the first drum with a rod-shaped article including a first susceptor includes:
providing the at least one seat of the plurality of seats of the first drum with the rod-shaped article having the longitudinal axis substantially parallel to the rotational axis.

Example Ex8: The method according to one or more of the preceding Ex1-Ex7, wherein the rod-shaped article has a first end and a second end, and the first susceptor is located at the first end of the rod-shaped article, and wherein the step of inserting the rod-shaped article in the coil of the inductive sensor comprises:
inserting the rod-shaped article in the coil of the inductive sensor so that the first end of the rod-shaped article is located within the coil.

Example Ex9: The method according to one or more of the preceding Ex1-Ex8, wherein the step of discarding the rod-shaped article on the basis of the maximum value or the minimum value of the impedance comprises:
discarding the rod-shaped if the maximum value or the minimum value of the parameter function of the impedance is outside a pre-set range.

Example Ex10: The method of inspection of rod-shaped articles according to one or more of the preceding Ex1-Ex9, wherein the rod-shaped article has a first end and a second end and a second susceptor, the first susceptor being located at the first end of the rod-shaped article and the second susceptor being located at the second end of the rod-shaped article, and wherein the method comprises:
providing a second drum having a plurality of seats;
providing at least one seat of the plurality of seats of the second drum with an inductive sensor comprising a coil;
transferring the rod-shaped article from the first drum to the second drum so that the rod-shaped article is housed in the at least one seat of the plurality of seats of the second drum;
inserting the rod-shaped article in the coil of the inductive sensor of the second drum so that the second end of the rod-shaped article is within the coil;
detecting a maximum value or a minimum value of the parameter function of the impedance of the coil during the insertion of the rod-shaped article;
discarding the rod-shaped article on the basis of the maximum value or the minimum value of the parameter function of the impedance.

Example Ex11: The method according to one or more of the preceding Ex1-Ex10, wherein the step of inserting the rod-shaped article in the coil of the inductive sensor comprises:
sliding the rod-shaped article on a bottom surface of the seat so as to insert the rod-shaped article in the coil.

Example Ex12: The method according to Ex11, wherein the step of sliding the rod-shaped article on a bottom surface of the seat so as to insert the rod-shaped article in the coil comprises:
pushing the rod-shaped article inside the coil by means of an air flow.

Example Ex13: The method according to one or more of Ex1-Ex10, wherein the coil includes a first semi-coil and a second semi-coil, the first semi-coil and the second semi-coil being movable from a first operative position where the first semi-coil and the second semi-coil are in contact to each other forming the coil where current can flow to a second operative position where the first semi-coil and the second semi-coil are separated from each other and no current can flow, and vice-versa, wherein the step of inserting the rod-shaped article in the coil of the inductive sensor comprises:
moving the first semi-coil and the second semi-coil from the second operative position to the first operative position.

Example Ex14: The method according to one or more of the preceding Ex1-Ex13, comprising the step of:
calibrating the inductive sensor using a rod-shaped article including a first susceptor or a second susceptor or both having a length equal to a nominal length.

Example Ex15: The method according to one or more of the preceding Ex1-Ex14, wherein the rod-shaped article includes a component of an aerosol generating article.

Example Ex16: The method according to one or more of the preceding Ex1-Ex15, wherein the parameter function of the impedance of the coil is the impedance itself Z of the coil, or the equivalent resistance R of the coil, or the inductance L of the coil.

Example Ex17: The method according to one or more of the preceding Ex1-Ex16, wherein the rod-shaped article includes an aerosol generating article or a component of an aerosol generating article.

Example Ex18: The method according to Ex17, wherein the aerosol-generating article includes an aerosol forming substrate.

Example Ex19: The method according to Ex18, wherein the aerosol forming substrate comprises a homogenized tobacco material.

Example Ex20: The method according to Ex18 or Ex19, wherein the aerosol forming substrate surrounds the susceptor.

Example Ex21: Method to produce a rod-shaped article including an aerosol generating article or a component of an aerosol generating article including an aerosol forming substrate, said method comprising the step of inspecting the rod-shaped articles according to the method of one or more of the preceding Ex1-Ex20.

Examples will now be further described with reference to the figures in which:

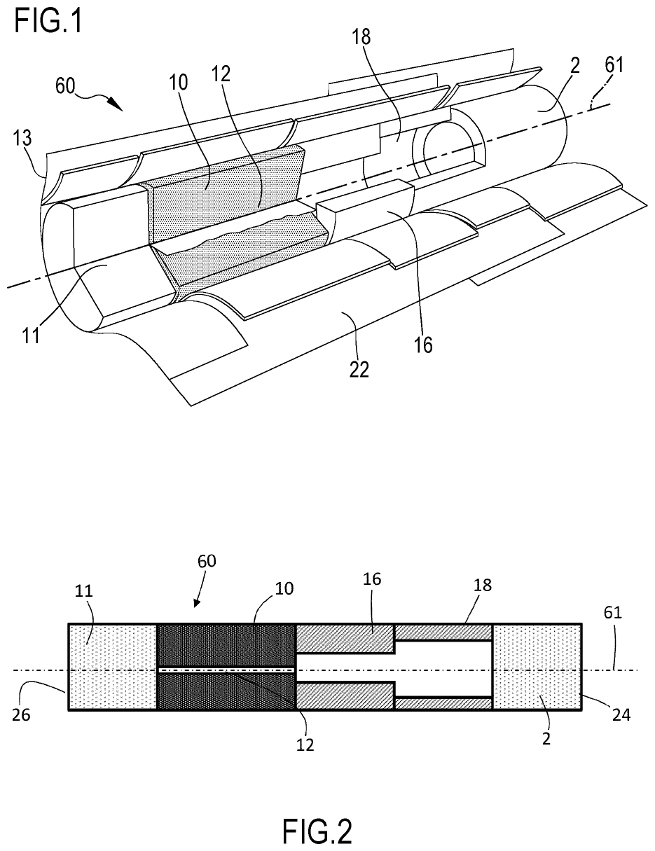

FIG. 1 is a schematic perspective view partially sectioned of a rod-shaped article including a susceptor to be inspected according to the method of the invention;

FIG. 2 is a lateral view of the rod-shaped article of FIG. 1;

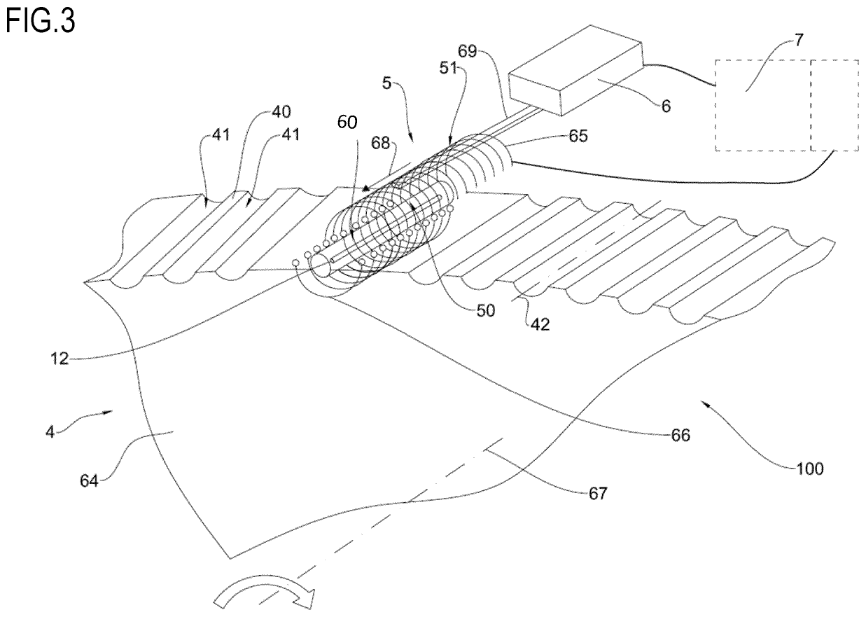

FIG. 3 is a schematic perspective view of an inspection device functioning according to a first embodiment of the present invention in a first configuration;

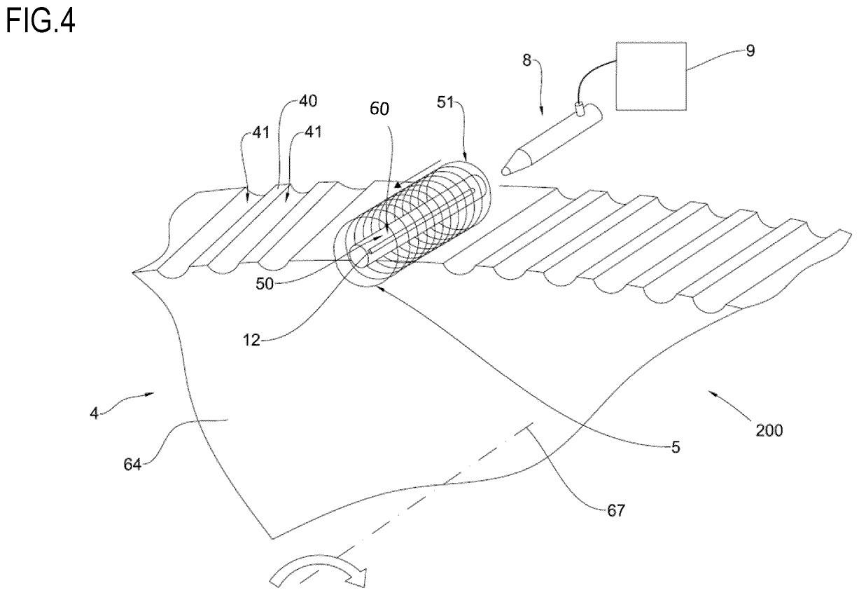

FIG. 4 is a schematic perspective view of an inspection device functioning according to a second embodiment of the present invention;

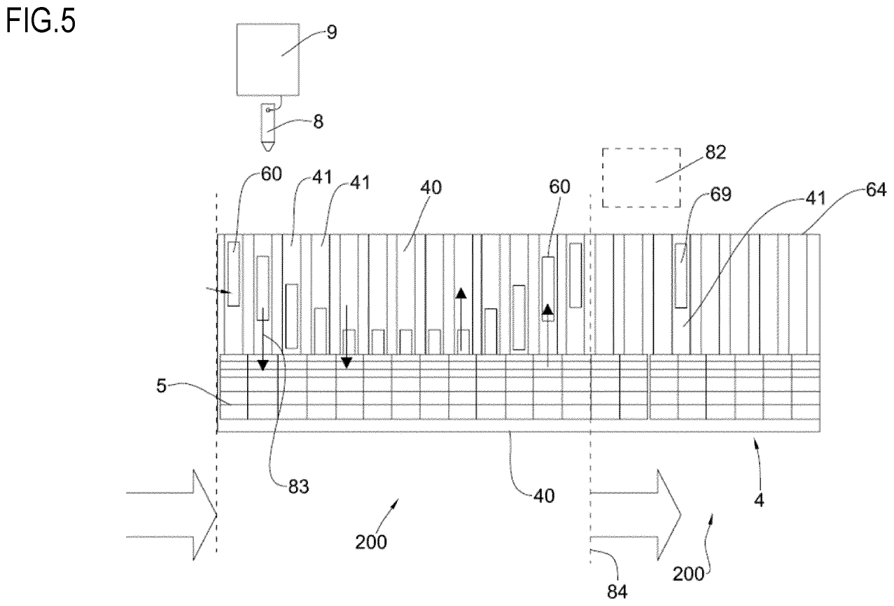

FIG. 5 is a schematic top view of the inspection device of FIG. 4 in a time sequence;

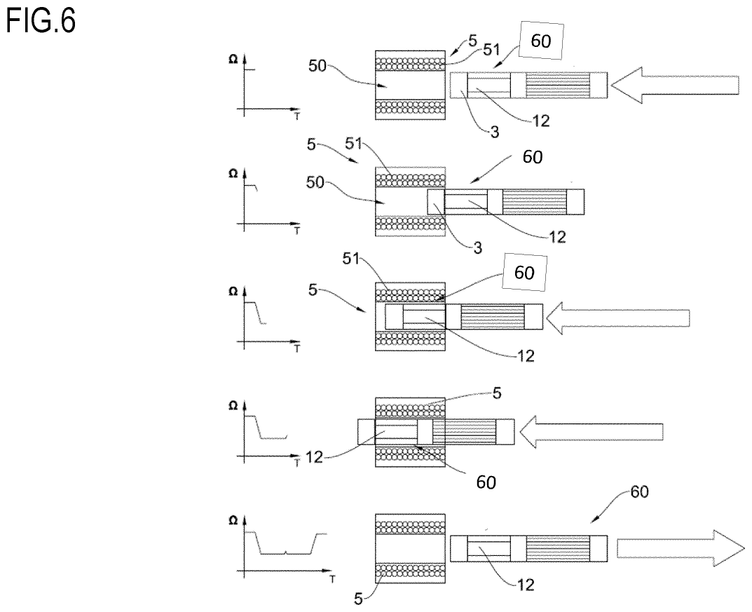

FIG. 6 is a sequence of steps of the functioning of the inductive sensor present in the inspection device of the invention;

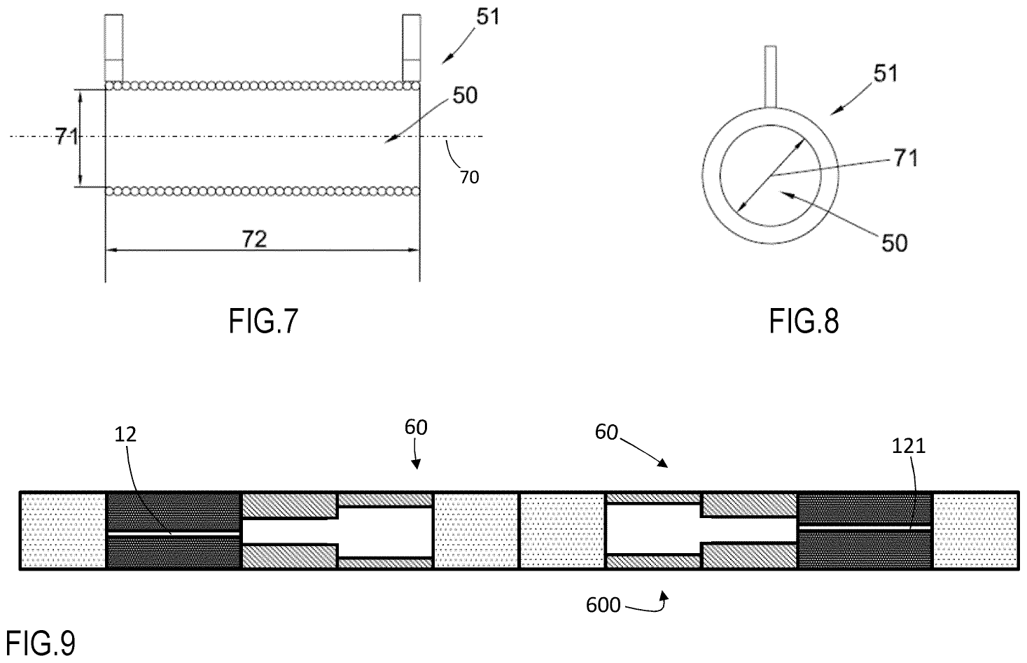

FIG. 7 is a detailed view in section of an element of the inspection device of FIG. 3, 4 or 5;

FIG. 8 is a front view of the element of FIG. 7;

FIG. 9 is a lateral view of another embodiment of the rod-shaped article to be inspected according to the invention;

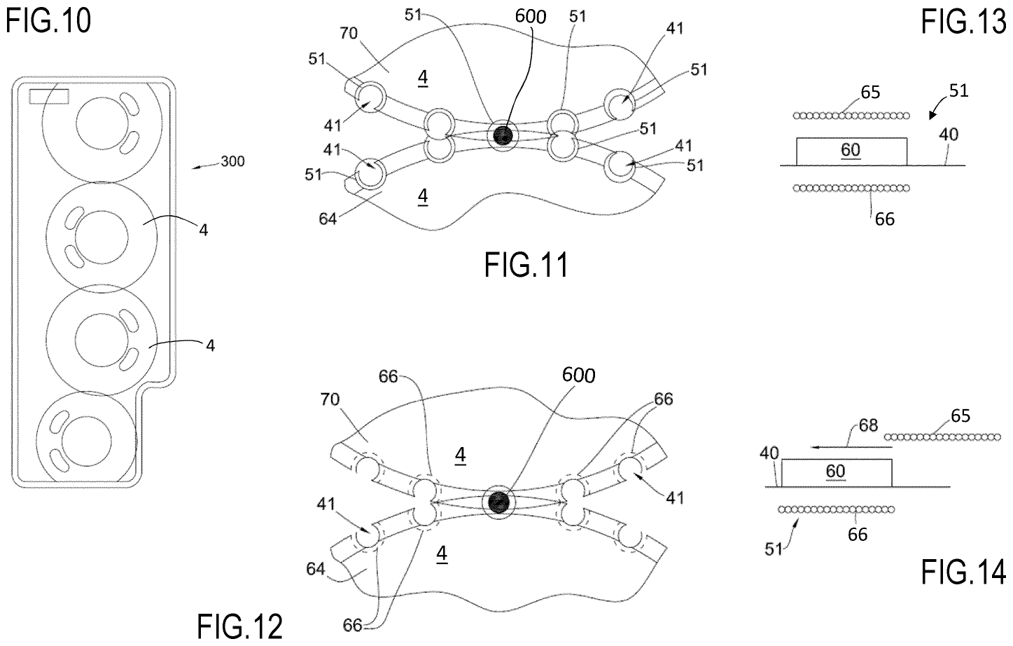

FIG. 10 is a third embodiment of an inspection device functioning according to the invention;

FIGS. 11 and 12 are two enlarged view of two details of FIG. 10 in two different embodiments;

FIG. 13 and FIG. 14 are two sectional views of the coil of the first embodiment of the inspection device of FIG. 3 in a first and in a second configuration, respectively.

With initial reference to FIGS. 1 and 2, an example of a rod-shaped article is globally indicated with 60.

Preferably, the rod-shaped article 60 comprises several components of an aerosol generating article, for example a complete aerosol generating article.

The aerosol-generating article 60 comprises for example a plurality of elements assembled in the form of a rod. The plurality of elements may comprise a plug element 11, an aerosol-forming substrate 10 in the form of a tobacco plug, a susceptor material 12 positioned within the aerosol-forming substrate 10, a hollow acetate tube 16, a further hollow acetate tube 18, a mouthpiece 2, and an outer wrapper 22. The aerosol-generating article 60 comprises a mouth end 24 and a distal end 26. The rod-shaped article 60 defines a longitudinal axis 61.

Preferably, the plurality of elements above listed develops along the longitudinal axis 61 of the rod-shaped article 60 one after the other. Preferably, all the elements have the same diameter.

Preferably, a cross section of the rod-shaped article 60 along a plane perpendicular to its longitudinal axis 61 is a circle.

The rod-shaped article 60 comprises an outer surface 13, preferably substantially cylindrical, which extends along the longitudinal axis 61. The longitudinal axis 61 of the rod-shaped article 60 may correspond to the axis of the cylinder.

The aerosol forming substrate 10 may include homogenized tobacco material.

The susceptor 12 is preferably in thermal contact with the aerosol forming substrate 10 such that, when the susceptor is inductively heated, heat is transferred to the aerosol forming substrate 10 and aerosol is thereby released. Preferably, the susceptor 12 is completely surrounded by the tobacco material forming the aerosol forming substrate 10.

As shown in the example of FIGS. 1 and 2, the susceptor 12 is completely contained in the rod-shaped article 60, more preferably it is completely contained in the aerosol forming substrate 10.

The susceptor 12 is realized in a conductive material. Preferably, the susceptor is realized in metal and, in some embodiments, it is realized in ferromagnetic material.

According to preferred embodiments, as in FIGS. 1 and 2, the susceptor 12 has the shape of a strip. Alternatively, it may have the shape of a rod. Preferably, its thickness is comprised between 30 micrometers and 60 micrometers. Preferably, the length of the susceptor is comprised between 5 millimetres and 20 millimetres.

FIG. 3 shows a portion of a preferred embodiment of a drum 4 of an inspection device 100 according to a first aspect of the present invention.

For the sake of clarity, the inspection device 100 is only partially shown in FIG. 3.

As it will be apparent from the following description, the inspection device 100 is adapted to control the quality of rod-shaped articles 60, and in particular of the susceptor 12.

Quality control provided by inspection device 100 may entail checking either the presence, integrity or precise position of the susceptor 12, as well as further characteristics of the latter.

By way of non-limiting example, such characteristics may include on ore more of the following: length of the susceptor, thickness of the susceptor, deviation of the susceptor from a rectilinear development, deviation of the susceptor's axis from parallelism with the longitudinal axis 61 of the rod-shaped article 60, electromagnetic properties of the susceptor.

Also, the quality control may take place at any stage of the manufacturing process of the aerosol generating article. This means that the rod-shaped article 60 could be checked when the aerosol forming substrate 10 is joined to the mouth piece filter element 2, or to any other component to be fixed thereto, or the aerosol forming substrate 10 including the susceptor 12 can be checked on its own.

With again reference to FIG. 3, the drum 4 comprises a plurality of seats 41 each of them being adapted to receive a rod-shaped article 60. The seats 41 are preferably located on an outer surface 40 of the drum 4. Preferably, there are between about 20 and 60 seats 41 in the drum 4, preferably about 40.

In some embodiments, the drum 4 is cylindrical shaped and, preferably, the outer surface 40 onto which the seats 41 are located corresponds to the lateral surface of the cylinder.

It will be appreciated that the seats 41 are preferably dimensioned and shaped in order to receive, at least partially, the rod-shaped article 60. Preferably, the dimensions and shapes of the seats 41 are selected so as to either receive the rod-shaped article 60. More in general, quality control preferably includes positioning the rod-shaped article 60 in one of the seats 41.

Positioning of the rod-shaped article 60 may occur either by using a suitable positioning device, not shown in the drawings, or by transferring the rod-shaped article 60 in any other possible manner, for example from another drum or conveyor.

In some embodiments, the inspection device 100 may be included in an apparatus for manufacturing aerosol generating articles and the rod-shaped article 60 may be transferred to the inspection device 100 from a conveyor element of the apparatus.

Preferably, drum 4 is a rotating drum having a rotational axis 67. Accordingly, the drum 4 allows to transfer the rod-shaped article 60 from a first position to a second position, preferably forming an entry where it is positioned on the seat and an exit positon where it is removed from the seat. The first position and the second position (not depicted in the drawing 3) are separated by an angular rotation of the drum.

In some embodiments, the seats 41 may be oblong shaped, so as to define a respective seat axis 42. Preferably, the seat axis 42 of the seat 41 and the rotational axis 67 are parallel to each other. Preferably all axes 42 of the plurality of seats 41 are parallel to each other.

The seats 41 are preferably formed on an outer surface 40 of the drum 4. The seats 41 may be in the form of recesses realized on the outer surface 40 of the drum 4.

Nevertheless, it is well evident that seats 41 may be defined by other elements on the outer surface of the drum 4, for example fixed thereto and radially projecting therefrom.

Preferably, the drum 4 defines a front face 64 and a rear face (not visible in the figures). The rear face is axially opposite to the front face 64.

In some embodiments, the seats 41 extends from the front face 64 to the rear face, that is the seats may be provided with opposed open ends.

In this manner, the rod-shaped article 60 may be received in the seat 41 by approaching it laterally, preferably by sliding along the direction define by the seat axis 42.

As shown in the embodiment of FIG. 3, the seats 41 may have a length at least equal to the length of the rod-shaped article 60 to be checked. Longer seats 41, allowing sliding of the rod-shaped article 60 therein may be used as well.

In some embodiments, the rotational axis 67 of the drum 4 is substantially horizontal.

The seats 41 may be configured such that the rod-shaped article 60 is discharged from the seat 41, when it reaches a specific angular position along rotational axis 67 in which gravity acts on the rod-shaped articles 60 in order to release it from the drum 4.

The inspection device 100 further comprises an inductive sensor 5 positioned at least at one of the plurality of seats 41. It will be appreciated that although the embodiment of FIG. 3 represents a single inductive sensor 5 positioned at a specific seat 41, each seat 41 of the drum 4 may comprise a respective inductive sensor 5.

Also, according to further possible embodiments, inductive sensors 5 may be provided at selected seats 41, for example at predetermined angular distance.

Preferably, the inductive sensor 5 includes a coil 51 defining an inner volume 50 large enough to receive therein at least an end of the rod-shaped article 60.

FIGS. 7 and 8 show the coil 51 according to a preferred embodiment.

Preferably, the coil 51 defines a coil axis 70 and has an internal diameter 71 comprised between 10 millimetres and 18 millimetres and, more preferably, comprised between 12 millimetres and 16 millimetres. Preferably, the internal diameter 71 of the coil 51 is 14 millimetres.

It will be appreciated that the above diameters are selected in order to make the coil 51 wide enough to receive therein the mouth end 24 or the distal end 26 of the rod-shaped article 60 but, at the same time, to avoid bulky elements to be used in the inspection device 100.

In some embodiments, the length of the coil 51 is adapted to wholly house therein the rod-shaped article 60.

Preferably, the length 72 of the coil is comprised between 20 millimetres and 40 millimetres, more preferably, comprised between 25 millimetres and 35 millimetres. Preferably, the length 72 of the coil 51 is 32 millimetres.

In some embodiments, the coil 51 is formed by a pair of parallel wounded-up wires.

Preferably, the coil 51 comprises a number of total turns comprised between 26 and 46. More preferably, the number of turns is comprised between 30 and 42. Preferably, the number of turns is 32.

In case the coil 51 is formed by a pair of wires, each wire may comprise half of the total number of turns mentioned above.

The coil 51 is preferably cylindrically shaped. Preferably, the coil 51 is positioned at the seat so that the coil axis 70 is parallel to the seat axis 42.

The presence of the susceptor 12 in the rod-shaped article 60 may be sensed by moving the rod-shaped article 60 relative to coil 51 and by considering a variation in a feedback signal generated by the interaction between the susceptor 12 and the coil 51.

To this end, in some embodiments as in FIG. 3, the inspection device 100 comprises a control unit 7 electrically connected to the inductive sensor 5 and adapted to receive the signal from the inductive sensor 5 and to compare it with a threshold in order to detect the variation of the signal generated by the presence of the susceptor 12.

It will be appreciated that such variation of the signal may be caused either by moving the coil 51 with respect to the rod-shaped article 60, as in the example of FIG. 3, or by moving the rod-shaped article 60 with respect to the coil 51 as in the embodiment of FIG. 4 or FIG. 5.

In general, it will be appreciated that the inductive sensor 5 may generate an alternative magnetic field in the coil 51 which is altered when passed through by the susceptor 12. More in general, the inductive sensor 5 is configured to generate an alternative magnetic signal in a detection direction, preferably corresponding to the axis 70 of the coil 51.

Preferably, the magnetic field generated by the inductive sensor 5 is altered when a first end 24, 26 of the rod-shaped article 60 in which the susceptor 12 is supposed to be located is received in the inner volume 50 of the coil 51 of the inductive sensor 5.

In other words, the magnetic field generated by the passage of the susceptor 12 through the inner volume 50 of the inductive sensor 5 acts against the magnetic field generated by sensor 5, that is, by the coil 51. According to the Lenz law the susceptor 12 acts as a resistance in the coil 51 or more in general in the inductive sensor 5.

In further detail, when a ferromagnetic material enters the field, an electromagnetic force is induced in it (Maxell-Faraday law) which creates alternative Eddy currents. This alternative current generates an induced magnetic field (Maxell-Ampere law), which is in opposition to the sensor magnetic field (Lenz law).

Presence or absence of the susceptor 12 in the rod-shaped article 60 may be accordingly determined in view of such expected behaviour in the magnetic field. If no alternation occurs when a rod-shaped article 60 passes through the alternative magnetic field generated by the coil 51, then no susceptor 12 is likely to be present in the rod-shaped article 60.

By contrast, alternation may be determined by calculating the impedance of the rod-shaped article 60, that varies as the susceptor 12 passes through the inner volume 50 of coil 51, as previously explained.

According to preferred embodiments, the feedback signal generated as the susceptor 12 passes through the inner volume 50 can be used for determining other characteristics of the susceptor 12.

With reference to FIG. 6, a possible use of the feedback signal may be directed to determine the length of the susceptor 12.

FIG. 6 shows how the equivalent resistance of the system “coil and susceptor” varies according to the relative position of the susceptor 12 in the inner volume 50.

Initially, when the rod-shaped article 60 has not entered the inner volume 50 the feedback signal outputted by the inductive sensor 5 is not altered.

As the rod-shaped article 60 enters the inner volume 50, a variation in the feedback signal occurs.

The feedback signal will reach a minimum level when the whole susceptor 12 has fully entered the inside volume 50, and will begin to decrease as soon as the end of the susceptor 12 will go out of the coil 51.

By comparing this signal to the positions of the rod-shaped article 60 inside the inner volume 50, it is possible to determine the length of the susceptor 12.

Preferably, the susceptor 12 length is estimated according to a peak of a measure equivalent resistance, determined after a suitable calibration.

Alternatively, the parameter function of the impedance shows a maximum, and not a minimum, when the susceptor is fully inserted in the coil.

In such embodiments, the coil 51, or more in general the inner volume 50 of the induction sensor 5, is longer than the expected length of the susceptor 12, also according to the previously mentioned characteristics of the coil.

Preferably, the length of coil 51 is selected so as to be longer than the expected length of the susceptor 12 of at least 10 millimetres per side, to avoid magnetic field distortions at the end of the coil.

According to preferred embodiments, the control unit 7 is configured to determine if the length of the susceptor 12 corresponds to an expected value, by checking the variation of the feedback signal according to the position of the rod-shaped article 60 in the inner volume 50.

It will be appreciated that the control unit 7 may be adapted to calculate the length of the susceptor 12 located in the rod-shaped article 60 also according to different methods, for example taking in general into account other specific behaviour of the inductive sensor 5 during interaction of the rod-shaped article 1 with the inner volume 50.

More in general, the equivalent resistance of the feedback signal may be indicative of the nature or consistency of shape or composition of the susceptor 12. Accordingly, further characteristic of the susceptor 12 may be determined by the inspection device 100 of the invention.

In order to introduce the rod-shaped article 60 in the coil 51, in the inspection device 100 of FIG. 3, the coil 51 is divided in two semi-coils 65 and 66. The first semi-coil 66 is positioned below the outer surface 40 of the drum 4, while the first semi-coil is positioned above the outer surface 40 of the drum. The two semi-coils 65, 66 can move from a first operative position shown in FIG. 13, in which they form the coil 51. In this first operative position, the measurements described above by the inductive sensor and shown for example in FIG. 6 can be performed. The second operative position depicted in FIGS. 3 and 13, the second semi-coil 65 is moved along the coil axis 70 and distanced from the first semi-coil, so that a rod-shaped article 60 can be located in the seat 41. The movement is performed by means of an actuator 6 connected to the control unit 7.

In the inspection device 100 of FIGS. 3, 13, and 14, during operation, the rod-shaped articles 60 are inserted in seats 41. When the rod-shaped articles are positioned in the seats, the first semi-coil 66 and the second semi-coil 65 are in the second operative position, that is, the two semi-coils 65, 66 are separated from each other, as in FIGS. 3 and 14. As soon as the rod-shaped article 60 is in the seat, the first semi-coil 66 and second semi-coil 65 are moved to the first operative position of FIG. 13 so that the measurement with the inductive sensor 5 can take place. The relative movement of the first semi-coil and the second semi-coil is as follow: the first semi-coil 66 is positioned below the outer surface 40 and it is fixed with respect to the same, while the second semi-coil 65 translates back and forth from the first operative position of FIG. 14 to the second operative position of FIGS. 3 and 14, and vice-versa. The shifting of the second semi-coil 65 from the first operative position to the second operative position and vice-versa is obtained by means of a piston 69 connected to the actuator 6. The piston 69 is attached to the second semi-coil to move it linearly towards and away the first semi-coil, as shown by arrow 68 of FIG. 3 In a different embodiment of the invention, which is depicted in FIGS. 4 and 5, instead of a movement of the coil with respect to the rod-shaped article as in the embodiment of FIGS. 3, 13 and 14, a movement of the rod-shaped article 60 with respect to the coil 51 takes place. In the inspection device 200, identical reference numbers as in inspection device 100 are used to identify the same elements. In the inspection device 200, the inductive sensor 5 includes coil 51 which is in this case attached to the outer surface 40 of the drum 4. The coil 51 (better seen in FIGS. 7 and 8) is for example located at one end of the seat 41. The inspection device 200 includes a compressed air system 8, 9 including a compressed air generator 9 and a gun 8 to eject a flow of compressed air. The gun may eject a flow of compressed air in a direction substantially parallel to the seat axis 42 and thus parallel to the longitudinal axis of the rod-shaped article 60. The gun may be located at one side of the drum 4 and may be stationary, that is, it does not rotate with the drum. In this way, a single compressed air system may be used for all seats 41. During rotation, when a rod-shaped article passes in front of gun 8, a flow of compressed air is ejected, which pushes the rod-shaped article 60 inside the coil 51 and the measurement above described can take place, using inductive sensor 5. This is shown in FIG. 5 where a series of “screenshots” taken at consecutive time intervals is depicted. In the far left of the figure, a rod-shaped article 60 is inserted in the seat 41. In the subsequent rotation, the seat with the rod-shaped article 60 passes in front of gun 8 and a flow of compressed air is ejected along direction 83 by gun 8. The rod-shaped article 60 is then pushed inside coil 51 (see the following snapshots from left to right of the figure, till dotted line 64).

Dotted line 84 separates FIG. 5 in two. The second part on the right of dotted line 84 of FIG. 5 is taken several time intervals later than the left part (see details below).

The inspection device 100, 200 of the present invention may also comprise a rejection device (schematically depicted in the right part of FIG. 5 as a rectangle 82), adapted to reject rod-shaped articles 60 that has no susceptor 12 therein, or has a susceptor 12 which is not complaint with expected characteristics. As previously explained, the rod-shaped articles 60 may be advantageously rejected on the basis of the signal emitted by the induction sensor 5, according to calculation or determination made by the control unit 7. As shown in the right portion of FIG. 5, for example, the effect of the rejection device 82 is to keep the rod-shaped article 60 which are defective in the drum 4, while the valid rod-shaped articles 60 are transferred to other drums (not shown) to continue processing.

Rod shaped articles 600 may include also a first susceptor 12 and a second susceptor 121, as depicted in FIG. 9. Rod-shaped articles 600 substantially include two rod-shaped articles 60 according to the embodiment of FIGS. 1 and 2.

In case a rod-shaped article 600 includes more than one susceptor, an inspection device according to a third embodiment is preferably provided, as inspection device 300 of FIG. 10.

The inspection device 300 includes two or more checking drums 4, at least a first drum and a second drum, each of which includes a coil 51. The first drum or the second drum are identical to drum 4, which can be according either to the first embodiment of FIGS. 3 and 13-14 or to the second embodiment of FIG. 4 or 5. The drums however are preferably of the same type, that is, either according to the first embodiment of inspection device 100, or according to the second embodiment of inspection device 200.

The first drum 4 is adapted to check the first susceptor 12 of the rod-shaped article 600, while the second drum 4 is adapted to check the second susceptor 121 of the rod-shaped article 600. For example, if the first drum and second drum are according to the second embodiment of FIGS. 4 and 5, in the first drum the compressed air system is located at the first side surface of the first drum, and in the second drum the compressed air system is located at the second side surface of the second drum.

From the first drum, after the inspection of the first susceptor 12, the rod-shaped article 600 is transferred to the second drum, as depicted in FIGS. 11 and 12. The first drum and second drum are substantially tangent to each other. The gap between the first drum and second drum is such that a rod-shaped article 600 can be inserted therebetween. The transfer takes place between a seat of the first drum and a seat of the second drum.

In FIG. 11, the transfer is shown between two drums 4 according to the first embodiment of FIGS. 3, 13, 14. In FIG. 12, the transfer is shown between two drums 4 according to the second embodiment of FIGS. 4, 5.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10 percent of A. Within this context, a number A may be considered to include numerical values that are within general standard error for the measurement of the property that the number A represents. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. Method of inspection of rod-shaped articles, the method comprising:
providing a first drum having a plurality of seats;
providing at least one seat of the plurality of seats of the first drum with an inductive sensor comprising a coil;
providing the at least one seat of the plurality of seats of the first drum with a rod-shaped article including a first susceptor, the first susceptor comprising a conductive material;
inserting the rod-shaped article in the coil of the inductive sensor;
detecting a maximum value or a minimum value of a parameter function of an impedance of the coil during the insertion of the rod-shaped article;
discarding the rod-shaped article on a basis of the maximum value or the minimum value of the parameter function of the impedance.

2. The method according to claim 1, including:
comparing the maximum value or the minimum value of a parameter function of the impedance with a threshold;
discarding the rod-shaped article on the basis of the comparison.

3. The method according to claim 1, comprising:
measuring a length of the first susceptor on the basis of the maximum value or the minimum value of the parameter function of the impedance of the coil during the insertion of the rod-shaped article.

4. The method according to claim 1, comprising:
measuring the parameter function of the impedance of the coil as a function of time during the insertion of the rod-shaped article.

5. The method according to claim 4, comprising:
measuring a length of the first susceptor on the basis of a profile defined by the parameter function of the impedance of the coil as a function of time during the insertion of the rod-shaped article in the coil.

6. The method according to claim 1, wherein the first susceptor has a nominal length and the step of providing at least one seat of the plurality of seats of the first drum with an inductive sensor comprising a coil includes:
providing at least one seat of the plurality of seats of the first drum with an inductive sensor comprising a coil having a length longer than the nominal length of the first susceptor.

7. The method according to claim 1, wherein the rod-shaped article has a longitudinal axis and the first drum has a rotational axis, and wherein the step of providing the at least one seat of the plurality of seats of the first drum with a rod-shaped article including a first susceptor includes:
providing the at least one seat of the plurality of seats of the first drum with the rod-shaped article having the longitudinal axis substantially parallel to the rotational axis.

8. The method according to claim 1, wherein the rod-shaped article has a first end and a second end, and the first susceptor is located at the first end of the rod-shaped article, and wherein the step of inserting the rod-shaped article in the coil of the inductive sensor comprises:
inserting the rod-shaped article in the coil of the inductive sensor so that the first end of the rod-shaped article is located within the coil.

9. The method according to claim 1, wherein the step of discarding the rod-shaped article on the basis of the maximum value or the minimum value of the parameter function of the impedance comprises:
discarding the rod-shaped if the maximum value or the minimum value of the parameter function of the impedance is outside a pre-set range.

10. The method of inspection of rod-shaped articles according to claim 1, wherein the rod-shaped article has a first end and a second end and a second susceptor, the first susceptor being located at the first end of the rod-shaped article and the second susceptor being located at the second end of the rod-shaped article, and wherein the method comprises:
providing a second drum having a plurality of seats;
providing at least one seat of the plurality of seats of the second drum with an inductive sensor comprising a coil;
transferring the rod-shaped article from the first drum to the second drum so that the rod-shaped article is housed in the at least one seat of the plurality of seats of the second drum;
inserting the rod-shaped article in the coil of the inductive sensor of the second drum so that the second end of the rod-shaped article is within said coil;
detecting a maximum value or a minimum value of the parameter function of the impedance of said coil during the insertion of the rod-shaped article;
discarding the rod-shaped article on the basis of the maximum value or the minimum value of the parameter function of the impedance.

11. The method according to claim 1, wherein the step of inserting the rod-shaped article in the coil of the inductive sensor comprises:
sliding the rod-shaped article on a bottom surface of the seat so as to insert the rod-shaped article in the coil.

12. The method according to claim 11, wherein the step of sliding the rod-shaped article on a bottom surface of the seat so as to insert the rod-shaped article in the coil comprises:
pushing the rod-shaped article inside the coil by means of an air flow.

13. The method according to claim 1, wherein the coil includes a first semi-coil and a second semi-coil, the first semi-coil and the second semi-coil being movable from a first operative position where the first semi-coil and the second semi-coil are in contact to each other forming the coil where current can flow to a second operative position where the first semi-coil and the second semi-coil are separated from each other and no current can flow, and vice-versa, wherein the step of inserting the rod-shaped article in the coil of the inductive sensor comprises:
moving the first semi-coil and the second semi-coil from the second operative position to the first operative position.

14. The method according to claim 1, comprising the step of:
calibrating the inductive sensor using a rod-shaped article including a first susceptor or a second susceptor or both having a length equal to a nominal length.

15. The method according to claim 1, wherein the rod-shaped article includes a component of an aerosol generating article.
